(19) United States
(12) Patent Application Publication
(10) Pub. No.: US 2017/0135139 A1
(43) Pub. Date: May 11, 2017

(54) SYSTEM FOR AUTOMATICALLY ADJUSTING THE ASSIGMENT, FEATURES AND FUNCTIONALITY OF ORGANIZATIONAL SMART DEVICES

(71) Applicants: Cameron M. Laghaeian, Leesburg, VA (US); Brian A. Lemaster, Manassas, VA (US)

(72) Inventors: Cameron M. Laghaeian, Leesburg, VA (US); Brian A. Lemaster, Manassas, VA (US)

(21) Appl. No.: 15/348,273

(22) Filed: Nov. 10, 2016

Related U.S. Application Data
(60) Provisional application No. 62/253,594, filed on Nov. 10, 2015.

(51) Int. Cl. H04W 76/02; H04W 4/00; H04W 4/02

(52) U.S. Cl. CPC H04W 76/021; H04W 4/02; H04W 4/008; H04W 76/023

(57) ABSTRACT

A system for automatically adjusting the functionality of organizational smart devices is provided. The system associates beacons with each user having a smart device, wherein the smart devices and beacons are communicatively connected in a wireless network providing a systemic server. Based on user identification via their associated beacon and a proximity of each user to thereto, the systemic server automatically conveys functionality to each smart device assigned to a beacon-associated user. The present invention enables organizational staff to assign the smart devices to the users so that each smart device has appropriate features and functionality tailored to each user during their visit. Once a beacon is de-assigned or a smart device deactivated or no longer in range, the smart device is no longer conveyed tailored functionality and or is locked.

### CROSS-REFERENCE TO RELATED APPLICATION

This application claims the benefit of priority of U.S. provisional application No. 62/253,594, filed 10 Nov. 2015, the contents of which are herein incorporated by reference.

### BACKGROUND OF THE INVENTION

The present invention relates to management of organizational smart devices and, more particularly, to a beacon-based or RFID-based system for automatically adjusting the assignment, features and functionality of organizational smart devices.

The biggest barrier for organizations, such as museums and hospitals, in providing smart devices for the visitors and patients is the management of these smart devices. When providing a smart connected device for guest, visitors and/or patients, it is important to be able to identify the specific user the device is being assigned to, provides user-specific features and functionality, protect users' confidential information from being accessed by unauthorized users, and preventing the loss or theft of the smart devices.

Currently, if any organization decides to temporarily or permanently assign a smart device to a user the smart device must be configured manually for the user's specific needs, requiring the time of a staff member with technical knowledge of the underlying software and applications. The involvement of technical staff makes this activity cost prohibitive and impractical to undertake for cost conscious organizations to utilize smart devices for their guests, patients, visitors, etc. Furthermore, in order to mitigate the concern of user's confidential information being accessible to a subsequent, unauthorized user, a further requirement of the time of the staff member with technical knowledge would be needed. Currently, the alternative is to provide a smart device with generic software and applications that provides no added value and that are not adapted to provided features and functionality tailored to specific users, such devices commonly deter the storage and thus use of personal/confidential information that could be compromised. All while having staff members monitor the users and smart devices that have been assigned to them so they are not lost or stolen.

As can be seen, there is a need for a beacon-based or RFID-based system for automatically adjusting the assignment, features and functionality of organizational smart devices, wherein the entire assignment and unassignment of organizational smart devices are fully automated, requiring no technical knowledge by the staff members who will assign these devices and no support by technical staff for the entire operation. Whereby, assigning a smart device to a visitor, guest or a client is as easy as handing them a notepad and taking the notepad back when they are about to be discharged or leave.

### SUMMARY OF THE INVENTION

In one aspect of the present invention, a method for automatically adjusting the functionality of organizational smart devices includes associating a plurality of systemic beacons with a plurality of users; associating a plurality of smart devices with the plurality of systemic beacons; coupling each smart device of the plurality of smart devices to an associated systemic beacon of the plurality of beacons; communicatively connecting the plurality of smart devices to a network environment that includes a systemic server providing a plurality of user identifications providing with a plurality of device functionality; assigning each applicable user identification of the plurality of user identifications to each systemic beacon associated with the plurality of users; and automatically conveying the plurality of device functionality to the plurality of smart devices associated with the plurality of system beacons based on a relative proximity of each smart device to its respective associated systemic beacon of the plurality of beacons, and based on said applicable user identification assigned to said respective associated systemic beacon. The relative proximity is dependent on the needs of the organization deploying the invention. For example a hospital would set the proximity requirement between the patient's beacon or RFID and the smart device to be no more than six feet when assigning the device and no more than three feet when the device would lock up if a patient is separated from the device.

In another aspect of the present invention, the method for automatically adjusting the functionality of organizational smart devices includes positioning at least one stationary systemic beacon so as to define at least one physical location; associating a plurality of systemic beacons with a plurality of users; associating a plurality of smart devices with the plurality of systemic beacons, wherein each smart device of the plurality of smart devices is configurable to a deactivated state, and wherein each systemic beacon of the plurality of systemic beacons is configurable to a de-authorized state; coupling each smart device of the plurality of smart devices to an associated systemic beacon of the plurality of beacons; communicatively connecting the plurality of smart devices to a network environment that includes a systemic server providing a plurality of user identifications providing with a plurality of device functionality and user information; assigning each applicable user identification of the plurality of user identifications to each systemic beacon associated with the plurality of users, wherein each applicable user identifications is based on a classification of each user of the plurality of users or based on a permission to access a portion of the at least one physical location of each user of the plurality of users; and automatically conveying the plurality of device functionality and user information to the plurality of smart devices not in the deactivated state and associated with the plurality of system beacons not in the de-authorized state and based on a relative proximity of each smart device to its respective associated systemic beacon of the plurality of beacons, on said applicable user identification assigned to said respective associated systemic beacon, on a relative proximity of each smart device to the at least one stationary systemic beacon, and only to smart devices.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention;

FIG. 2 is a flowchart of an exemplary embodiment of the present invention;

FIG. 3 is a flowchart of an exemplary embodiment of the present invention;

FIG. 4 is a flowchart of an exemplary embodiment of the present invention; and

FIG. 5 is a flowchart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a beacon-based or RFID-based system for automatically adjusting the assignment, features and functionality of organizational smart devices through embodying wireless personal area network technology by utilizing beacons or RFID. Thereby, the present invention enables the organizational staff to assign the organizational smart devices to a particular guest-user without any additional effort to enter the user's information. Once a user has registered as a guest-user, a systemic beacon or RFID tag may be assigned to the guest-user. This beacon or RFID may then be utilized by systemic mobile software on the associated smart device to provide the appropriate features and functionality tailored to the specific guest-user during the guest-user's visit. Once the guest-user checks out or unregisters, the systemic beacon or RFID will be de-assigned, resetting the smart device for the next reassignment. The smart device may be adapted to automatically lock up if the beacon or RFID assigned to the device is no longer in range or is de-assigned.

The reassignment of the smart devices also requires the specific systemic beacon or RFID assigned to the authorized hospital staff to be activated. When a new guest-user checks in to an organization (for example, a new visitor to a museum, a new student at a university library, a new patient to a hospital, and the like), the system beacon or RFID may be assigned to the patient and any available organizational smart device which is not currently assigned will be handed to the guest-user at check-in time by an authorized person of the organization, who may also have a systemic beacon or RFID programmed and recognized by the smart device. The smart device may prompt the staff to assign the device to the patient with the systemic beacon or RFID, and upon verification by the authorized person, will provide the proper application features to the guest-user based on the guest information associated with the user-guest, such as a room or department the guest-user will be substantially assigned to within the organization. Upon discharge, the guest-user's systemic beacon or RFID may be unassigned, signaling the smart device to unassign itself and be available for further reassignment to a new guest-user.

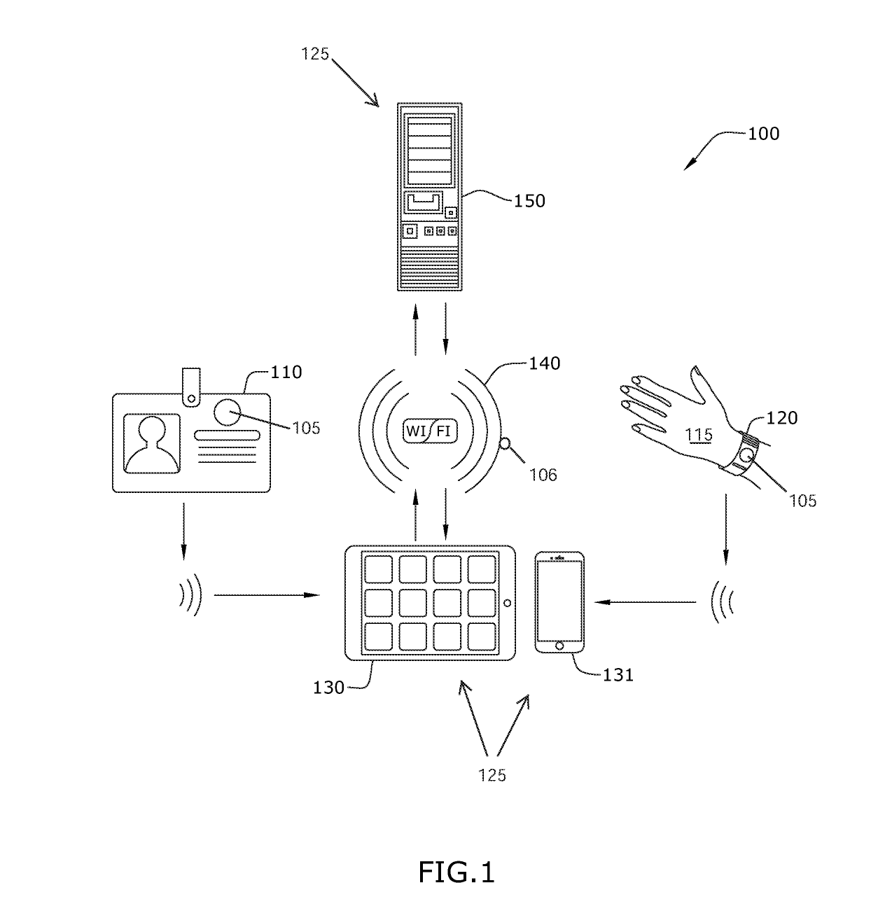

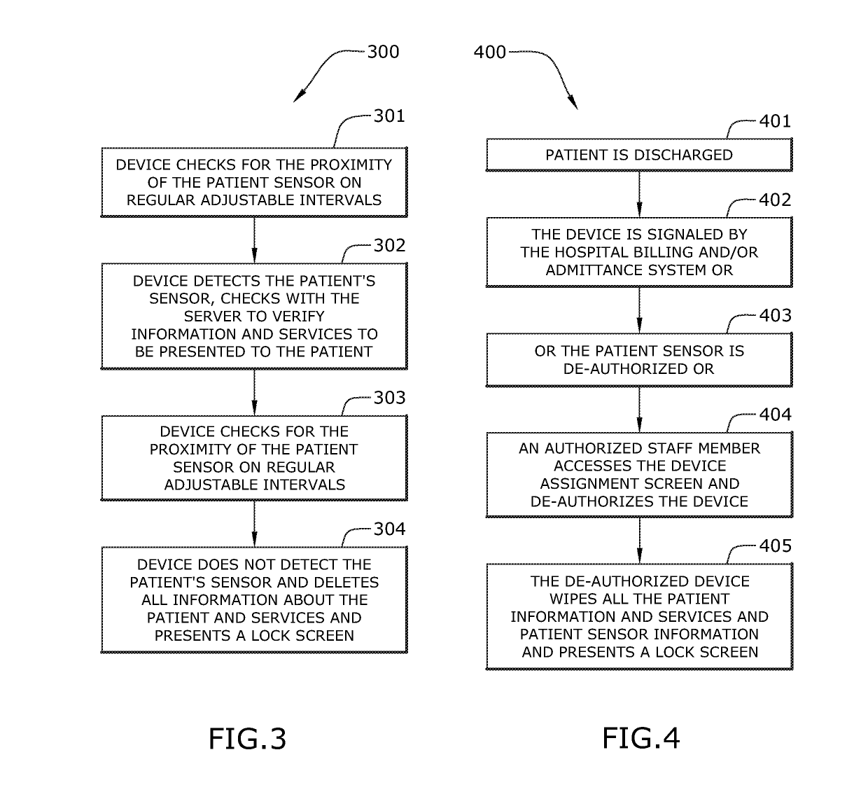

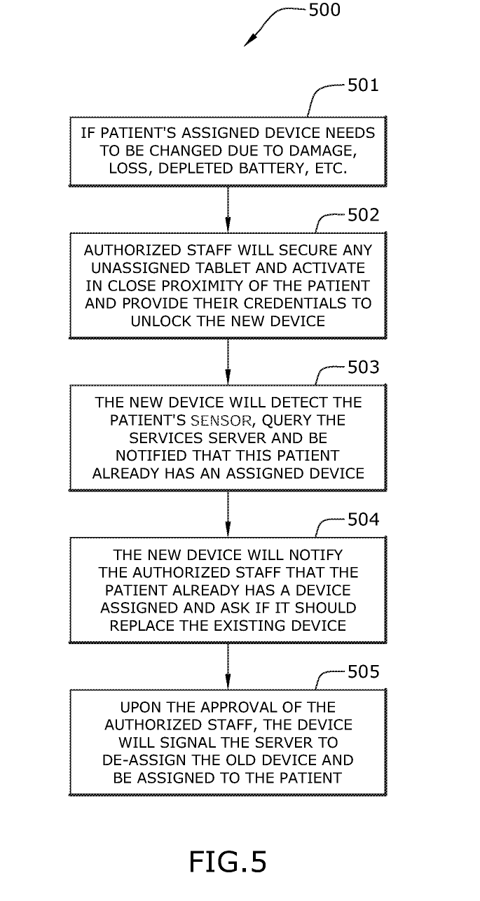

Referring to FIGS. 1 through 5, the present invention may include a beacon-based or RFID-based system 100 for automatically adjusting the assignment, features and functionality of organizational computing devices 125.

The present invention may include at least one computer 125 with a user interface. The computer 125 may include at least one processing unit coupled to a form of memory including, but not limited to, a computing device, a server 150, a desktop, a laptop, and smart device 130, such as, a tablet, a smart phone 131 or the like. The computer 125 may include a program product including a machine-readable program code for causing, when executed, the computer 125 to perform steps. The program product may include software which may either be loaded onto the computer or accessed by the computer 125. The loaded software may include an application on a smart device 130. The software may be accessed by the computer 125 using a web browser. The computer 125 may access the software via the web browser using the internet, extranet, intranet, host server, internet cloud, wifi network 140, and the like.

Referring to FIG. 1, an organization may establish a networked environment, such as a Wi-Fi network 140, wherein computers 125 (or computing devices, including smart devices 130 and smart phones 313) can be aware of, exchange information with, and be selectively coupled to a systemic server 150 and systemic beacons or RFID's 105, each beacon or RFID 105 capably of being associated with a user 115. Each device computing device 125 can be associated with a systemic beacon or RFID 105, which in turn is associated with a specific (guest-)user 115 of the organization. Each user 115 can be associated with a computing device 125. Thereby, the systemic server 150 may be adapted to determine the features and functionality of each computing device 125 based on in part the systemic beacon or RFID associated with the user 115 of said computing device 125.

The systemic beacons or RFID's 105 may be can include RFID tags, GPS transceivers, BLUETOOTH transceivers, and other such devices, or be Bluetooth Low Energy (BLE) beacons or the like. The systemic beacons or RFID 105 may be embedded within a device commonly carried by user 115, such as a user's name tag, badge 110, wristband 120 and the like.

The systemic server 150 can be a computing device loaded with systemic server software adapted to constantly track the locations of devices 125 and users 115 and to update each device 125 with predetermined features and functionality linked to its associated user 115. Different triggering conditions and events can be programmed within the systemic server 150 to determine settings for each features and functionality. Triggering conditions can depend upon device 125 specification and user 115 specific information. The systemic server 150 can determine whether existing features and functionality on a device 125 are usable for an environment in which the receiving device 125 is currently located. That is, features and functionality and confidential information may be selectively enabled/disabled depending upon whether the device 125 is located in a predetermined area of the networked environment of the organization.

Identification of specific locations of a user 115 during their stay, may be established by installing stationary systemic beacons or RFID's 106 throughout the physical locations of the organization within the networked environment. Whereby, the systemic server 150 can include mapping or a grid of the physical locations so as to map respective devices' locations within the grid.

The systemic server software may be adapted so as to be embedded with information used to specify data about the associated devices 125 or users 115, whereby the organization can also enter specific behaviors for various guest-user classifications. For example, the device is rendered inoperative if it leaves the confines of the organization).

Upon accepting a guest-user 115, presumably through an authorized staff member or person, the organization could assign a systemic beacon or RFID 105 to the user 115. This beacon or RFID 105 could be assigned to a user information entered into the systemic server software which would help identify the user name, application features for the user 115, the assigned location for the user 115 during their visit, etc.

The authorized person may be identified through their own specific systemic beacon or RFID 105 empowering them to assign any computing device 125 that has a systemic mobile software already installed to the user's beacon or RFID 115.

During discharge, the authorized person may unassign the systemic beacon or RFID 105 assigned to the user 115 being discharged using the systemic server software which would un-assign the systemic mobile software.

In certain embodiments, if the user 115 is separated from the computing device 125, systemic mobile software may lock the device unless the assigned user 115 or an authorized person gains control of the device 125.

If location-based stationary beacons or RFID's 106 are also deployed, and if the systemic mobile software is not able to detect a stationary beacon or RFID 106, the present invention may also lock the computing device 125 unless it is returned back to an assigned location and accessed by the specific user 115 it is assigned to or by an authorized person.

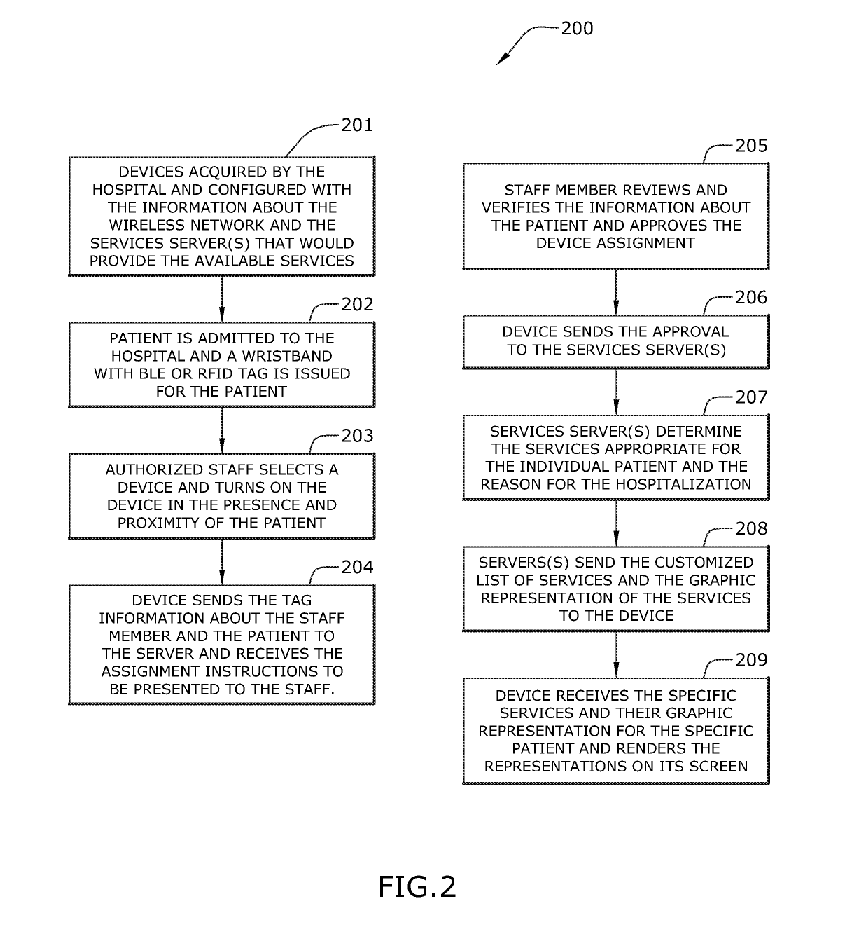

Referring to FIGS. 2-5, the methods embodying by the beacon-based or RFID-based system 10 can begin in step 201, where devices 125 acquired by the organization and configured with the information about the wireless network 140 and the systemic server 150 that would provide the available services. In step 202, a user 115 may be admitted to the organization and a wristband 120 with the systemic beacon or RFID 105/RFID tag embedded therein is issued to said user 115. In step 203, authorized staff selects a device 125 and turns on the device 125 in the presence and proximity of the associated user 115. In step 204, the device 125 sends the beacon or RFID 105/RFID tag information about the authorized staff member and the user 115 to the systemic server 150 and receives the assignment instructions to be presented to the staff. In step 205, the authorized staff member reviews and verifies the information about the user 115 and approves the device assignment. In step 206, the device 125 sends the approval to the systemic server 150. In step 207, the systemic server 150 determines the services appropriate for the user 115 and the reason for their presence in the organization. In step 208, the systemic server 150 sends the customized list of services and the graphic representation of the services to the device 125. In step 209, the device 125 receives the specific services and their graphic representation for the specific user 115 and renders the representation on its user interface/screen.

In method 300, step 301, the device 125 checks for the proximity of the user sensor on regular adjustable intervals. In step 302, the device 125 detects the user's sensor, checks with the systemic server 150 to verify information and services to be presented to the user 115. In step 303, the device 125 checks for proximity of the user sensor on regular adjustable intervals. In step 304, the device 125 does not detect the user's sensor and deletes all information about the user and services and presents a lock screen.

In method 400, the user 115 is discharged from the organization in step 401. In step 402, the device 125 is signaled by the organization billing and/or admittance system, or the user sensor is de-authorized in step 402, or an authorized staff member accesses the device 125 assignment screen and de-authorizes the device 125. In step 405, the de-authorized devices wipes all the user information and services and user sensor information and presents a lock screen.

In method 500, if user's assigned device 125 needs to be changed due to damage, loss, depleted battery, etc., in step 501, the authorized staff will secure any unassigned tablet and activate in close proximity of the user 115 and provide their credentials to unlock the new device 125, in step 502. In step 503, the new device 125 will detect the user sensor, query the systemic server 150 and be notified that this user 115 already has an assigned device 125. In step 504, the new device 125 will notify the authorized staff that the user already has a device 125 assigned and ask if it should replace the existing device 125. In step 505, upon the approval of the authorized staff, the device 125 will signal the systemic server 150 to de-assign the old device 125 and be assigned to the user 115.

Additionally, through the present invention, smart devices can be assigned on an adhoc basis to locations, enabling organizations to monitor and report on various conditions in those locations.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for automatically adjusting the functionality of organizational smart devices, comprising:
associating a plurality of systemic beacons with a plurality of users;
associating a plurality of smart devices with the plurality of systemic beacons;
coupling each smart device of the plurality of smart devices to an associated systemic beacon of the plurality of beacons;
communicatively connecting the plurality of smart devices to a network environment that includes a systemic server providing a plurality of user identifications providing with a plurality of device functionality;
assigning each applicable user identification of the plurality of user identifications to each systemic beacon associated with the plurality of users; and
automatically conveying the plurality of device functionality to the plurality of smart devices associated with the plurality of system beacons based on a relative proximity of each smart device to its respective associated systemic beacon of the plurality of beacons, and based on said applicable user identification assigned to said respective associated systemic beacon.

2. The method of claim 1, wherein the plurality of user identifications provides user information automatically conveyed.

3. The method of claim 1, wherein each applicable user identification is based on a classification of each user of the plurality of users or based on at least one allowable physical locations of each user of the plurality of users.

4. The method of claim 1, wherein each smart device of the plurality of smart devices is configurable to a deactivated state, and wherein the automatic conveyance of the plurality of device functionality is prohibited to each smart device of the plurality of smart devices in the deactivated state.

5. The method of claim 1, wherein each systemic beacon of the plurality of systemic beacons is configurable to a de-authorized state, and wherein the automatic conveyance of the plurality of device functionality is prohibited to each systemic beacon of the plurality of systemic beacons in the de-authorized state.

6. The method of claim 1, further including positioning at least one stationary systemic beacon so as to define at least one permissible physical location, and wherein the automatic conveyance is based on a relative proximity of each smart device to the at least one stationary systemic beacon.

7. The method of claim 1, wherein each systemic beacon is a RFID.

8. A method for automatically adjusting the functionality of organizational smart devices, comprising:
positioning at least one stationary systemic beacon so as to define at least one physical location;
associating a plurality of systemic beacons with a plurality of users;
associating a plurality of smart devices with the plurality of systemic beacons, wherein each smart device of the plurality of smart devices is configurable to a deactivated state, and wherein each systemic beacon of the plurality of systemic beacons is configurable to a de-authorized state;
coupling each smart device of the plurality of smart devices to an associated systemic beacon of the plurality of beacons;
communicatively connecting the plurality of smart devices to a network environment that includes a systemic server providing a plurality of user identifications providing with a plurality of device functionality and user information;
assigning each applicable user identification of the plurality of user identifications to each systemic beacon associated with the plurality of users, wherein each applicable user identifications is based on a classification of each user of the plurality of users or based on a permission to access a portion of the at least one physical location of each user of the plurality of users; and
automatically conveying the plurality of device functionality and user information to the plurality of smart devices not in the deactivated state and associated with the plurality of system beacons not in the de-authorized state and based on a relative proximity of each smart device to its respective associated systemic beacon of the plurality of beacons, on said applicable user identification assigned to said respective associated systemic beacon, on a relative proximity of each smart device to the at least one stationary systemic beacon, and only to smart devices.

9. The method of claim 8, wherein each systemic beacon is a RFID.
